(19) United States
(12) Patent Application Publication
(10) Pub. No.: US 2024/0135299 A1
(43) Pub. Date: Apr. 25, 2024

(54) AUTOMATICALLY DETERMINING WORK ENVIRONMENT-RELATED ERGONOMIC DATA

(71) Applicant: Dell Products L.P., Round Rock, TX (US)

(72) Inventors: Feng Cheng Lee, Singapore (SG); Hao Yu Feng, Singapore (SG); Udara Liyanage, Singapore (SG); Wee Young Chua, Singapore (SG)

(21) Appl. No.: 17/969,434

(22) Filed: Oct. 18, 2022

(51) Int. Cl. G06Q 10/06; G06T 7/70

(52) U.S. Cl. CPC G06Q 10/06398; G06Q 10/06395; G06T 7/70; G06T 2207/30196

(57) ABSTRACT

Methods, apparatus, and processor-readable storage media for automatically determining work environment-related ergonomic data are provided herein. An example computer-implemented method includes obtaining ergonomic-related data pertaining to one or more of an individual within a work environment and the work environment; determining one or more ergonomic parameter values by processing at least a portion of the obtained ergonomic-related data using one or more models; generating and outputting, to the individual via one or more automated systems, at least one notification based at least in part on the one or more ergonomic parameter values; and performing one or more automated actions based at least in part on one or more of the one or more ergonomic values and the at least one notification.

### FIELD

The field relates generally to information processing systems, and more particularly to data processing using such systems.

### BACKGROUND

With an increased prevalence of individuals working from home and/or remotely, many such individuals no longer have access to working conditions available in a professional office setting. For example, home and/or remote work setups often lack office equipment such as ergonomic desks and/or ergonomic chairs. Additionally, working with such inferior equipment, particularly over prolonged periods of time, can affect not only productivity but also physical health. However, conventional workplace environment management techniques typically fail to analyze ergonomic parameters in connection with home and/or remote work settings.

### SUMMARY

Illustrative embodiments of the disclosure provide techniques for automatically determining work environment-related ergonomic data. An exemplary computer-implemented method includes obtaining ergonomic-related data pertaining to one or more of an individual within a work environment and the work environment, and determining one or more ergonomic parameter values by processing at least a portion of the obtained ergonomic-related data using one or more models. The method also includes generating and outputting, to the individual via one or more automated systems, at least one notification based at least in part on the one or more ergonomic parameter values, and performing one or more automated actions based at least in part on one or more of the one or more ergonomic values and the at least one notification.

Illustrative embodiments can provide significant advantages relative to conventional workplace environment management techniques. For example, problems associated with reduced productivity and increased physical health issues arising from home and/or remote work environments with inferior equipment are overcome in one or more embodiments through automatically determining and evaluating ergonomic data pertaining to an individual in a work environment.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically determining work environment-related ergonomic data in an illustrative embodiment.

FIG. 2 shows an example workflow for automatically determining work environment-related ergonomic data in an illustrative embodiment.

FIG. 3 is a flow diagram of a process for automatically determining work environment-related ergonomic data in an illustrative embodiment.

FIGS. 4 and 5 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

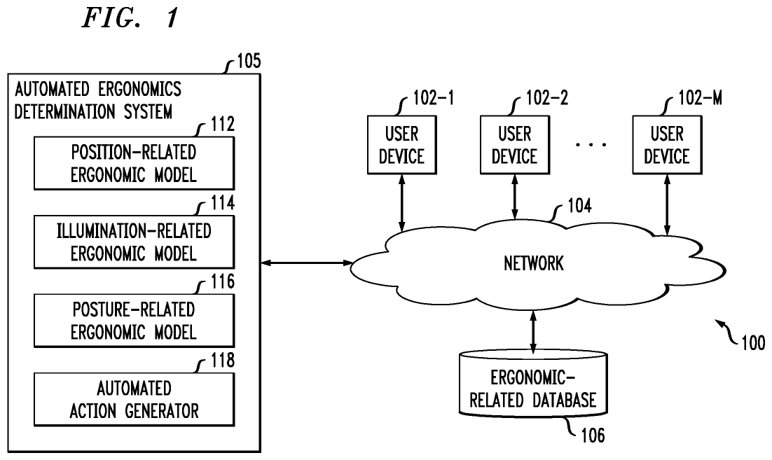

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is automated ergonomics determination system 105.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, automated ergonomics determination system 105 can have an associated ergonomic-related database 106 configured to store data pertaining to screen-related data, illumination-related data, user-related data, ergonomic-related data, etc.

The ergonomic-related database 106 in the present embodiment is implemented using one or more storage systems associated with automated ergonomics determination system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with automated ergonomics determination system 105 are one or more input-output devices, which illustratively comprise keyboards, displays or other types of input-output devices in any combination. Such input-output devices can be used, for example, to support one or more user interfaces to automated ergonomics determination system 105, as well as to support communication between automated ergonomics determination system 105 and other related systems and devices not explicitly shown.

Additionally, automated ergonomics determination system 105 in the FIG. 1 embodiment is assumed to be implemented using at least one processing device. Each such processing device generally comprises at least one processor and an associated memory, and implements one or more functional modules for controlling certain features of automated ergonomics determination system 105.

More particularly, automated ergonomics determination system 105 in this embodiment can comprise a processor coupled to a memory and a network interface.

The processor illustratively comprises a microprocessor, a central processing unit (CPU), a graphics processing unit (GPU), a tensor processing unit (TPU), a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows automated ergonomics determination system 105 to communicate over the network 104 with the user devices 102, and illustratively comprises one or more conventional transceivers.

The automated ergonomics determination system 105 further comprises position-related ergonomic model 112, illumination-related ergonomic model 114, posture-related ergonomic model 116, and automated action generator 118.

It is to be appreciated that this particular arrangement of elements 112, 114, 116 and 118 illustrated in the automated ergonomics determination system 105 of the FIG. 1 embodiment is presented by way of example only, and alternative arrangements can be used in other embodiments. For example, the functionality associated with elements 112, 114, 116 and 118 in other embodiments can be combined into a single module, or separated across a larger number of modules. As another example, multiple distinct processors can be used to implement different ones of elements 112, 114, 116 and 118 or portions thereof.

At least portions of elements 112, 114, 116 and 118 may be implemented at least in part in the form of software that is stored in memory and executed by a processor.

It is to be understood that the particular set of elements shown in FIG. 1 for automatically determining work environment-related ergonomic data involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, automated ergonomics determination system 105 and ergonomic-related database 106 can be on and/or part of the same processing platform.

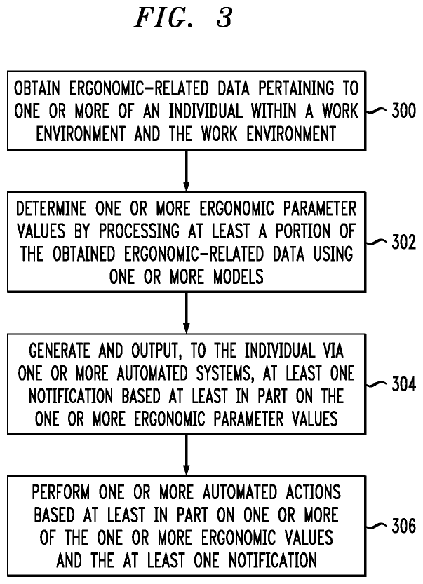

An exemplary process utilizing elements 112, 114, 116 and 118 of an example automated ergonomics determination system 105 in computer network 100 will be described in more detail with reference to the flow diagram of FIG. 3.

Accordingly, at least one embodiment includes assessing work environments of individuals working at home and/or remotely and generating and outputting one or more suggestive values in real-time to evaluate ergonomics associated with the individuals. Such an embodiment includes implementing an evaluation index referred to herein as a human computer ergonomics index, which includes one or more weightages of one or more parameters. The parameters can include real-time input data from one or more work environment-related sources (e.g., computer webcams, light sensors, microphones, etc.) and/or user feedback (e.g., user inputs pertaining to computer screen size, screen resolution, screen brightness, etc.).

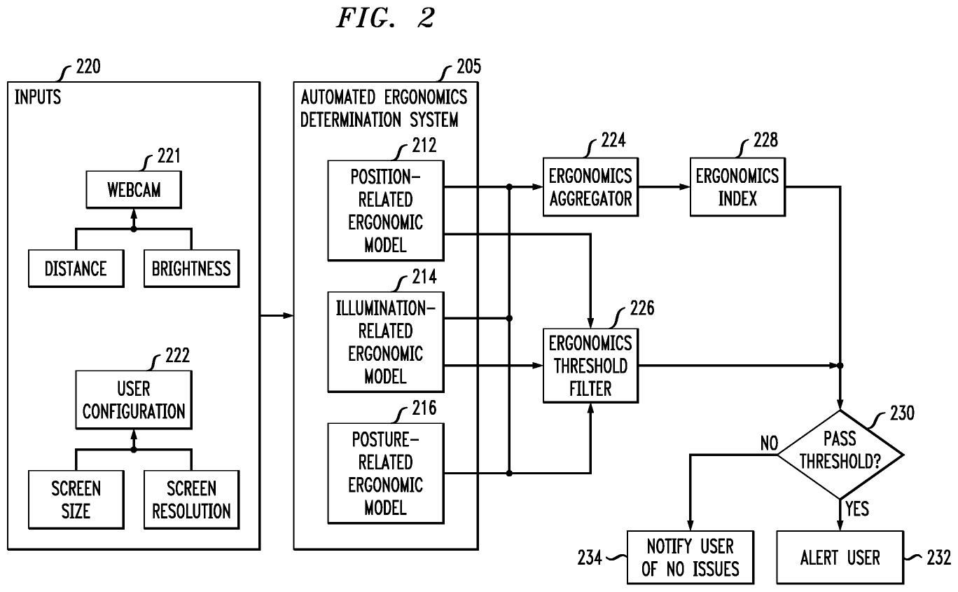

As depicted in FIG. 1 and FIG. 2, and further detailed herein, one or more embodiments includes implementing at least one position-related ergonomic model, which can process data input by and/or obtained from at least one camera (e.g., a webcam of the computer screen(s) in question) to determine one or more parameters pertaining to, for example, human position relative to at least one computer screen. In such an embodiment, depending on the screen size and the screen resolution (which can be processed by the model via user input, for example), at least one recommended distance can be determined (e.g., at least one recommended distance of the human user from the computer screen).

In at least one embodiment, a position-related ergonomic model determines a recommended distance based at least in part on a visual acuity distance, which is the distance that the human eye can read and/or process one or more details with a given level of precision. Additionally or alternatively, a position-related ergonomic model can determine a recommended distance based at least in part on predetermined minimum distances and predetermined maximum distances determined in connection with historical data and one or more trained artificial intelligence techniques. Accordingly, in one or more embodiments, a position-related ergonomic model generates a position-related ergonomic score for a given individual based at least in part on comparing one or more recommended distance values with the actual distance of the individual from the given screen (e.g., as determined and/or calculated using input data from the webcam associated with the given screen).

The recommended distances (e.g., a visual acuity distance, a recommended minimum distance between the individual and the screen, a recommended maximum distance between the individual and the screen, etc.) are computed by the position-related ergonomic model based at least in part on the diagonal screen size and the screen resolution. In one or more embodiments, there is a linear relationship between the screen size and one or more of the recommended distance values. As further detailed below, the coefficients m and c for a linear equation can be used for computation of the recommended minimum distance, the recommended maximum distance, and the recommended visual acuity distance for the various screen resolution types (e.g., full high definition (HD), Quad HD, Ultra HD 4K, etc.). In such an embodiment, the m coefficient and the c coefficient represent the linear relationship (d=mx+c) between screen sizes x and recommended distance values d corresponding thereto. The m coefficient is the gradient of the linear graph, and the c coefficient is the intercept.

By way of example, in at least one embodiment, such a linear equation and/or relationship can be based at least in part on at least on distance value d and at least one screen size value x, such as provided by the following equation: d=mx+c. By way merely of illustration, in such an embodiment, a coefficient for a minimum distance value (mₘᵢₙ) can be 0.614, a coefficient for a maximum distance value (mₘₐₓ) can be 1.669, a coefficient for a visual acuity distance value in connection with a full HD resolution screen (m_{va_fhd}) can be 1.511, a coefficient for a visual acuity distance value in connection with a Quad HD resolution screen (m_{va_qhd}) can be 1.173, a coefficient for a visual acuity distance value in connection with a ultra HD 4K resolution screen (m_{va_uhd}) can be 0.756, and a coefficient c can be 0.05. In connection with determining such example coefficient values, one or more embodiments include plotting graphs using different screen sizes against different minimum distance values, maximum distance values, and visual acuity distance values. After plotting the graphs, one or more linear graphs derived therefrom can be identified, and from the linear graphs, the m and c coefficient values can be derived and/or determined. The significance of the m and c coefficient values can include, for example, that the values represent the linear relationship between screen sizes and their corresponding distance values.

For example, in one or more embodiments, input in the form of diagonal screen size x can be used to generate an output in the form of a recommended minimum distance between the user and the screen (dₘᵢₙ). Additionally, in such an embodiment, input in the form of screen resolution R can be used to generate outputs in the form of a recommended maximum distance between the user and the screen (dₘₐₓ) and a recommended visual acuity distance (dᵥₐ).

Accordingly, in at least one embodiment, in connection with input R for a full HD resolution screen (e.g., a screen having 1920 pixels horizontally across the screen and 1080 pixels vertically across the screen), a visual acuity distance formula can be given as dᵥₐ=m_{va_fhd}x+c; a minimum distance formula can be given as dₘᵢₙ=mₘᵢₙx+c; and a maximum distance formula can be given as dₘₐₓ=mₘₐₓx+c.

Additionally or alternatively, in connection with input R for a Quad HD resolution screen (e.g., a screen having 2560 pixels horizontally across the screen and 1440 pixels vertically across the screen), a visual acuity distance formula can be given as dᵥₐ=m_{va_qhd}x+c; a minimum distance formula can be given as dₘᵢₙ=mₘᵢₙx+c; and a maximum distance formula can be given as dₘₐₓ=mₘₐₓx+c.

Further, in such an embodiment, in connection with input R for an ultra HD 4K resolution screen (e.g., a screen having 3840 pixels horizontally across the screen and 2160 pixels vertically across the screen), a visual acuity distance formula can be given as dᵥₐ=m_{va_uhd}x+c; a minimum distance formula can be given as dₘᵢₙ=mₘᵢₙx+c; and a maximum distance formula can be given as dₘₐₓ=mₘₐₓx+c. Accordingly, in one or more embodiments, across the different screen resolution categories, the same minimum distance formula and the same maximum distance formula are used. The different R inputs do not make a difference for mₘᵢₙ and mₘₐₓ coefficients, but the different R inputs do make a difference for the mᵥₐ (visual acuity) coefficient.

Also, in one or more embodiments, to determine an ergonomic score e associated with user position from a given screen, input for such a computation can include the actual distance (dₐ) that the user is from screen, which can be determined and/or retrieved using, for example, a webcam associated with the given screen. In such an embodiment, input for the computation can also include a recommended minimum distance value, a recommended maximum distance value, and a visual acuity distance value, such as calculated as detailed above. Accordingly, in at least one embodiment, a decision-based condition can be determined based at least in part on the actual distance value and the visual acuity distance value, and the corresponding formulas for computing the score can be defined as follows. Given a condition wherein dₘᵢₙ<dₐ<dᵥₐ, the ergonomic score formula, with respect to user position/distance from the given screen, is given as follows:

$$e = \frac{( {d}_{a} - {d}_{min} )}{( {d}_{v a} - {d}_{min} )} .$$

Additionally, given a condition wherein dᵥₐ≤dₐ<dₘₐₓ, the ergonomic score formula, with respect to user position/distance from the given screen, is given as follows:

$$e = \frac{( {d}_{max} - {d}_{a} )}{( {d}_{max} - {d}_{v a} )} .$$

Further, given a condition wherein dₐ≤dₘᵢₙ and dₐ≥dₘₐₓ, the ergonomic score formula, with respect to user position/distance from the given screen, is given as follows: e=0.

The ergonomic score e, detailed above in connection with the three example conditions, can have a range, for instance, of zero to one, with zero being the worst/lowest score and one being the best/highest score. In the event of a low ergonomic score, one or more embodiments can include generating an output to indicate to the user that he or she is positioned too near the screen when dₐ<dᵥₐ, or positioned too far from the screen when dₐ>dᵥₐ.

As also depicted in FIG. 1 and FIG. 2, and further detailed herein, one or more embodiments includes implementing at least one illumination-related ergonomic model, which can process inputs in the form of, for example, illumination values captured and/or obtained using one or more ambient light sensors, one or more cameras (e.g., webcam(s)) associated with a given screen and/or work environment, etc. Such a model can be implemented to determine one or more parameters related to illumination, such as, for example, lighting brightness in a given space and/or room within a work environment.

In one or more embodiments, such a model can process inputs such as screen brightness values L, which can be determined and/or indicated (e.g., as a percentage value) via the corresponding operating system (OS). Based at least in part on the determined screen brightness value, at least one embodiment includes computing a recommended environmental illuminance value (i_{R}) using, for example, a formula such as follows: i_{R}=0.36*L². In such an embodiment, 0.36 is a coefficient value (and it is to be appreciated that one or more other embodiments can include one or more different coefficient values).

In at least one embodiment, the recommended environmental illuminance (i_{R}) value can represent a room lighting metric that is recommended for the user's eyes, and iₐ can represent actual illumination in the room. Accordingly, in such an embodiment, if iₐ<i_{R}, the user can be notified to turn the room lights up or on, and if iₐ>i_{R}, the user can be notified to turn the room lights down or off.

In at least one embodiment, one or more ambient light sensors can be utilized to obtain and/or determine one or more actual environmental illuminance values (e.g., measured in lumen per meter square or lux). To determine the ergonomic score for lighting in room, such an embodiment can include implementing a formula which uses a recommended environmental illuminance (i_{R}) and an actual environmental illuminance value (iₐ). Additionally, in such an embodiment, let Lₘₐₓ be 100(%) which is the maximum screen brightness, in connection with a formula such as follows: i_{R}=k*Lₘₐₓ².

Given a condition wherein iₐ<i_{R}, the ergonomic score formula, with respect to illumination values for a given user environment, is given as follows: e=iₐ/i_{R}. Also, given a condition wherein i_{R}≤iₐ<iₘₐₓ, the ergonomic score formula, with respect to illumination values for a given user environment, is given as follows:

$$e = \frac{( {i}_{max} - {i}_{a} )}{( {i}_{max} - {i}_{R} )} .$$

Further, given a condition wherein iₐ≥iₘₐₓ, the ergonomic score formula, with respect to illumination values for a given user environment, is given as follows: e=0.

Additionally, as depicted in FIG. 1 and FIG. 2, and further detailed herein, one or more embodiments includes implementing at least one posture-related ergonomic model, which can calculate one or more angles or angle values of one or more joints and/or body parts of the user. For example, in at least one embodiment, such a model can be used to calculate one or more elbow angles which includes calculating a base joint related to the user's shoulder(s), a middle joint related to the user's elbow(s), and an outer joint related to the user's wrist(s). The model can also be used to calculate one or more leg angles which includes calculating a base joint related to a middle portion of the user's hip, a middle joint related to the user's knee(s), and an outer joint related to the user's ankle(s). Additionally, the model can be used to calculate one or more back angles which includes calculating a base joint related to the user's neck, a middle joint related to a middle portion of the user's hip, and an outer joint related to the user's knee(s).

In at least one embodiment, such angle calculations can be based at least in part on measurements (e.g., actual angles (dₐ)) determined and/or computed using video input and/or photographic input captured or obtained, for example, using a camera (e.g., a webcam) associated with the given screen and/or work environment. In one or more embodiments, such measurements (e.g., actual angles (dₐ)) are determined by taking a screenshot using a webcam of the given device, and calculating the distance from the user. Additionally or alternatively, at least one embodiment can include performing such calculations continuously and implemented the same as a frame in the webcam.

By way of illustration, in one or more embodiments, an optimal elbow angle calculation (dₒₚₜᵢₘₐₗ) is as close to 90 degrees as possible. In such an embodiment, the angles can be affected by multiple items, including the height of the desk or work surface relative to the seating height of the individual, and the distance of the screen from the individual. Such angles are based at least in part on an underlying assumption that the screen and/or computer is positioned on a flat desk or work surface. One or more other embodiments can include a scenario wherein the screen and/or computer is on a stand and/or mounted, which can change the distance of the screen from the individual and, hence, the optimal elbow angle.

In such an embodiment, an ergonomic score related to user posture can be computed using the following formula: e=(dₐ−dₒₚₜᵢₘₐₗ)/dₒₚₜᵢₘₐₗ.

In one or more embodiments, each of the above-noted parameters (e.g., position-related parameter(s), illumination-related parameter(s), and posture-related parameter(s)) can be determined and output to the user and/or one or more automated systems individually or in one or more combinations. For example, scenarios may occur wherein two or more parameters are correlated to each other, such as, for instance, the lighting of the room being related to how close the user is positioned from the given computer screen. Accordingly, in such a scenario, at least one embodiment can include normalizing the multiple parameters (also referred to herein as ergonomic scores) and aggregating the parameters to create an index.

For example, consider an implementation of one or more embodiments wherein the following parameters are determined: a first parameter p1 representing user position/distance from a given computer screen, a second parameter p2 representing a lighting value associated with the work environment/room, and a third parameter p3 representing sitting posture of the user. Further, in such an embodiment, weights can be applied to the difference parameters (e.g., based at least in part on user reactions and/or user preferences), such as, for example, a weight of 0.5 applied to the first parameter, a weight of 0.2 applied to the second parameter, and a weight of 0.3 applied to the third parameter. Accordingly, in such an embodiment, the corresponding ergonomics index can be calculated giving the following equation: ergonomics_{index}=p1*0.5+p2*0.2+p3*0.3.

Additionally, one or more embodiments include determining parameters (ergonomic scores) on a periodic and/or continuous basis. Accordingly, such an embodiment can include creating and/or implementing a notification engine that notifies the user when at least one predetermined threshold value associated with a single parameter and/or a combination of two or more parameters has been crossed (e.g., the parameter(s) value as crossed above or below the predetermined threshold value). In at least one embodiment, determining and/or setting the threshold values includes taking the minimum to optimal value as a base 100% and subsequently taking +−20% of the base as a guided principle of threshold.

FIG. 2 shows an example workflow for automatically determining work environment-related ergonomic data in an illustrative embodiment. By way of illustration, FIG. 2 depicts inputs 220, which includes distance and brightness inputs captured by webcam 221, and screen size and screen resolution inputs provided by the user as a user configuration 222. At least a portion of inputs 220 are provided to and/or processed by automated ergonomics determination system 205, which includes position-related ergonomic model 212, illumination-related ergonomic model 214, and posture-related ergonomic model 216. As illustrated in FIG. 2, each of model 212, model 214, and model 216 generates at least one parameter score (e.g., by processing at least a portion of inputs 220) and provides such score(s) to ergonomics aggregator 224 and ergonomics threshold filter 226.

As detailed above and herein, with respect to ergonomics threshold filter 226, the individual parameter scores (generated by model 212, model 214, and model 216) are each compared to a respective parameter-related predetermined threshold value, and if the given parameter score passes a given predetermined threshold in step 230 (e.g., exceeds the threshold value or falls below the threshold value), then at least one corresponding alert is generated and output to the user in step 232. Alternatively, if the given parameter score does not pass a given predetermined threshold in step, then at least one notification is generated and output to the user in step 234 to indicate that there are no issues.

With respect to ergonomics aggregator 224, the individual parameter scores (generated by model 212, model 214, and model 216) are combined and/or aggregated via at least one model or formula to generate an ergonomics index 228 (comprising, for example, a numerical value or score based on a weighted combination of the individual parameter scores). If the ergonomics index 228 passes a given predetermined threshold in step 230 (e.g., exceeds the threshold value or falls below the threshold value), then at least one alert is generated and output to the user in step 232.

By way of further illustration, consider the following example embodiment wherein an individual is working in the dining room at his or her home, and wherein the equipment includes a table as a makeshift desk and dim lighting sources. Further, in this example situation, assume that the computer screen is positioned (on the table) at a safe distance relative to the individual, and the chair being used is formal not designed for prolonged usage, resulting is poor sitting by the individual. Additionally, in such an example, one or more embodiments can include performing a parameter aggregation wherein a first parameter p1 pertaining to user position/distance form the computer screen has a results/parameter score of 80 (e.g., on a scale of 0-100) and a respective weight of 0.5, a second parameter p2 pertaining to lighting in the dining room has a results/parameter score of 30 and a respective weight of 0.2, and a third parameter p3 pertaining to user sitting posture has a results/parameter score of 40 and a respective weight of 0.3. Such values indicate, for example, that the user's position/distance from the computer screen is acceptable, while the dining room lighting and the user's sitting posture are both poor and/or unacceptable.

Hence, in such an example embodiment, an ergonomics index can be determined as follows:

$$\begin{matrix}{ergonomics}_{inde x} = p1 * 0.5 + p 2 * 0.2 + p3 * 0.3 \\ = 80 * 0.5 + 30 * 0.2 + 40 * 0.3 \\ = 40 + 6 + 12\end{matrix}$$

$$= 58$$

The result is an ergonomics index of 58 (e.g., on a scale of 0-100), which is poor. In such an example embodiment, an alert can be generated and output to the user indicating the ergonomic index and/or one or more of the individual parameter scores, as well as one or more recommendations automatically generated and output to the user and/or one or more external and/or automated systems, wherein such recommendations include recommendations for improving one or more aspects of the provided ergonomic data (e.g., one or more suggestions to improve lighting in the room, one or more suggestions to improve the user's sitting posture, etc.). In one or more embodiments, such recommendations are determined based at least in part on the individual ergonomics. For example, if the ergonomics index is poor, but within it, the posture and the screen-to-user distance is good while the brightness of the room is poor, a recommendation can be generated to adjust the brightness of the room, wherein such a recommendation is delivered and/or output to the user, e.g., via text on the screen.

By way of further illustration, another example use case can include a user using a room that is brightened up by natural light during the day, resulting in acceptable ergonomics scores. However, as the day becomes evening, and the natural light diminishes, the illumination in the room reaches a particular threshold (e.g., crosses below a predetermined level of brightness), and an alert is generated and output to the user, as well as an automatically generated recommendation that the user can then switch on one or more supplemental light sources in the room to improve the ergonomics index.

Additionally, one or more embodiments can include extending the techniques detailed herein beyond computer screens and/or monitors (e.g., desktop devices) to mobile devices such as smart phones, tablets, etc. Such an embodiment includes obtaining and/or determining a baseline of how a given user works (e.g., a week's worth of ergonomic data from the user's home and/or remote work environment), and using the baseline data to determine and/or optimize weights applied to various parameter scores to provide a customized scoring rubric with respect to the user and the given mobile device(s).

FIG. 3 is a flow diagram of a process for automatically determining work environment-related ergonomic data in an illustrative embodiment. It is to be understood that this particular process is only an example, and additional or alternative processes can be carried out in other embodiments.

In this embodiment, the process includes steps 300 through 306. These steps are assumed to be performed by automated ergonomics determination system 105 utilizing elements 112, 114, 116 and 118.

Step 300 includes obtaining ergonomic-related data pertaining to one or more of an individual within a work environment and the work environment. In at least one embodiment, obtaining ergonomic-related data includes capturing ergonomic-related data pertaining to the individual within the work environment using at least one camera associated with a device of the individual (also referred to herein as the user) and/or capturing ergonomic-related data pertaining to the work environment using at least one illumination sensor. Additionally or alternatively, obtaining ergonomic-related data can include obtaining ergonomic-related data pertaining to a device used by the individual within the work environment based at least in part on input from the individual.

Step 302 includes determining one or more ergonomic parameter values by processing at least a portion of the obtained ergonomic-related data using one or more models. In one or more embodiments, the one or more ergonomic parameter values include one or more of an ergonomic parameter value pertaining to the individual's distance from at least one device screen, an ergonomic parameter value pertaining to illumination in the work environment, and an ergonomic parameter value pertaining to the individual's posture. Additionally or alternatively, determining one or more ergonomic parameter values includes determining multiple ergonomic parameter values including two or more of an ergonomic parameter value pertaining to the individual's distance from at least one device screen, an ergonomic parameter value pertaining to illumination in the work environment, and an ergonomic parameter value pertaining to the individual's posture. In such an embodiment, determining multiple ergonomic parameter values includes generating an ergonomic index by aggregating the multiple ergonomic parameter values in conjunction with weights applied to the multiple ergonomic parameter values.

Step 304 includes generating and outputting, to the individual via one or more automated systems, at least one notification based at least in part on the one or more ergonomic parameter values. In at least one embodiment, generating the at least one notification includes generating the at least one notification based at least in part on a comparison of the one or more ergonomic parameter values to one or more respective predetermined threshold values.

Step 306 includes performing one or more automated actions based at least in part on one or more of the one or more ergonomic values and the at least one notification. In one or more embodiments, performing one or more automated actions includes generating and outputting, to the individual via one or more automated systems, one or more recommendations for improving at least one of the one or more ergonomic parameter values.

In such an embodiment, the one or more recommendations can include, for example, a recommendation to move the screen(s) closer to or farther from the individual and/or a recommendation for the individual to move (e.g., the individual's chair, the individual's standing position, etc.) closer to or farther from the screen(s). Additionally, the one or more recommendations can include, for example, a recommendation to increase and/or turn on one or more illumination sources in the individual's environment, and/or a recommendation to decrease and/or turn off one or more illumination sources in the individual's environment. Further, the one or more recommendations can include, for example, a recommendation for the individual to adjust and/or modify the position of one or more body parts (e.g., to improve and/or adjust the individual's posture).

Accordingly, the particular processing operations and other functionality described in conjunction with the flow diagram of FIG. 3 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to overcome problems associated with reduced productivity and increase physical health issues arising from home and/or remote work environments with inferior equipment. These and other embodiments can effectively automatically determine and evaluate ergonomic data pertaining to an individual working in a remote environment.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

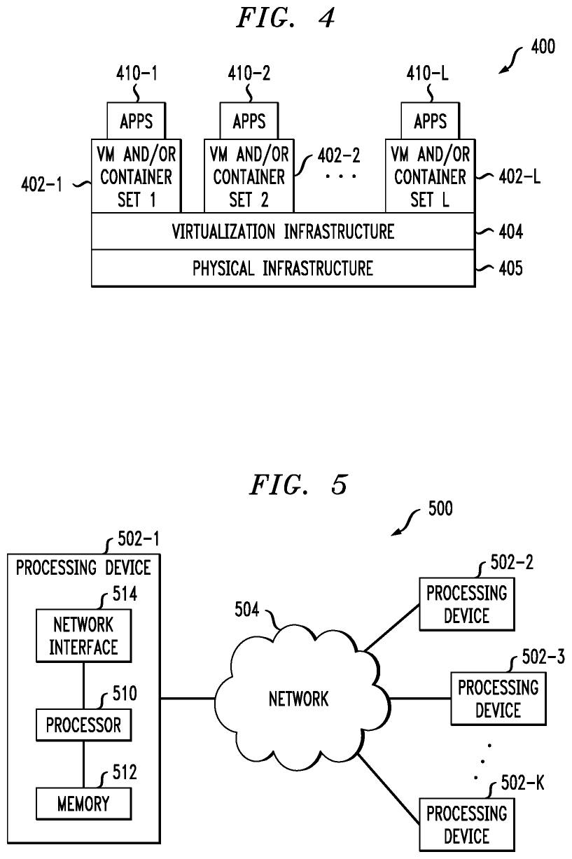

Illustrative embodiments of processing platforms will now be described in greater detail with reference to FIGS. 4 and 5. Although described in the context of system 100, these platforms may also be used to implement at least portions of other information processing systems in other embodiments.

FIG. 4 shows an example processing platform comprising cloud infrastructure 400. The cloud infrastructure 400 comprises a combination of physical and virtual processing resources that are utilized to implement at least a portion of the information processing system 100. The cloud infrastructure 400 comprises multiple virtual machines (VMs) and/or container sets 402-1, 402-2, . . . 402-L implemented using virtualization infrastructure 404. The virtualization infrastructure 404 runs on physical infrastructure 405, and illustratively comprises one or more hypervisors and/or operating system level virtualization infrastructure. The operating system level virtualization infrastructure illustratively comprises kernel control groups of a Linux operating system or other type of operating system.

The cloud infrastructure 400 further comprises sets of applications 410-1, 410-2, . . . 410-L running on respective ones of the VMs/container sets 402-1, 402-2, . . . 402-L under the control of the virtualization infrastructure 404. The VMs/container sets 402 comprise respective VMs, respective sets of one or more containers, or respective sets of one or more containers running in VMs. In some implementations of the FIG. 4 embodiment, the VMs/container sets 402 comprise respective VMs implemented using virtualization infrastructure 404 that comprises at least one hypervisor.

A hypervisor platform may be used to implement a hypervisor within the virtualization infrastructure 404, wherein the hypervisor platform has an associated virtual infrastructure management system. The underlying physical machines comprise one or more information processing platforms that include one or more storage systems.

In other implementations of the FIG. 4 embodiment, the VMs/container sets 402 comprise respective containers implemented using virtualization infrastructure 404 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 400 shown in FIG. 4 may represent at least a portion of one processing platform. Another example of such a processing platform is processing platform 500 shown in FIG. 5.

The processing platform 500 in this embodiment comprises a portion of system 100 and includes a plurality of processing devices, denoted 502-1, 502-2, 502-3, . . . 502-K, which communicate with one another over a network 504.

The network 504 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 510 coupled to a memory 512.

The processor 510 comprises a microprocessor, a CPU, a GPU, a TPU, a microcontroller, an ASIC, a FPGA or other type of processing circuitry, as well as portions or combinations of such circuitry elements.

The memory 512 comprises random access memory (RAM), read-only memory (ROM) or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining ergonomic-related data pertaining to one or more of an individual within a work environment and the work environment;
determining one or more ergonomic parameter values by processing at least a portion of the obtained ergonomic-related data using one or more models;
generating and outputting, to the individual via one or more automated systems, at least one notification based at least in part on the one or more ergonomic parameter values; and
performing one or more automated actions based at least in part on one or more of the one or more ergonomic values and the at least one notification;
wherein the method is performed by at least one processing device comprising a processor coupled to a memory.

2. The computer-implemented method of claim 1, wherein the one or more ergonomic parameter values comprise one or more of an ergonomic parameter value pertaining to the individual's distance from at least one device screen, an ergonomic parameter value pertaining to illumination in the work environment, and an ergonomic parameter value pertaining to the individual's posture.

3. The computer-implemented method of claim 1, wherein determining one or more ergonomic parameter values comprises determining multiple ergonomic parameter values comprising two or more of an ergonomic parameter value pertaining to the individual's distance from at least one device screen, an ergonomic parameter value pertaining to illumination in the work environment, and an ergonomic parameter value pertaining to the individual's posture.

4. The computer-implemented method of claim 3, wherein determining multiple ergonomic parameter values comprises generating an ergonomic index by aggregating the multiple ergonomic parameter values in conjunction with weights applied to the multiple ergonomic parameter values.

5. The computer-implemented method of claim 1, wherein performing one or more automated actions comprises generating and outputting, to the individual via one or more automated systems, one or more recommendations for improving at least one of the one or more ergonomic parameter values.

6. The computer-implemented method of claim 1, wherein generating the at least one notification comprises generating the at least one notification based at least in part on a comparison of the one or more ergonomic parameter values to one or more respective predetermined threshold values.

7. The computer-implemented method of claim 1, wherein obtaining ergonomic-related data comprises capturing ergonomic-related data pertaining to the individual within the work environment using at least one camera associated with a device of the individual.

8. The computer-implemented method of claim 1, wherein obtaining ergonomic-related data comprises capturing ergonomic-related data pertaining to the work environment using at least one illumination sensor.

9. The computer-implemented method of claim 1, wherein obtaining ergonomic-related data comprises obtaining ergonomic-related data pertaining to a device used by the individual within the work environment based at least in part on input from the individual.

10. A non-transitory processor-readable storage medium having stored therein program code of one or more software programs, wherein the program code when executed by at least one processing device causes the at least one processing device:
to obtain ergonomic-related data pertaining to one or more of an individual within a work environment and the work environment;
to determine one or more ergonomic parameter values by processing at least a portion of the obtained ergonomic-related data using one or more models;
to generate and output, to the individual via one or more automated systems, at least one notification based at least in part on the one or more ergonomic parameter values; and
to perform one or more automated actions based at least in part on one or more of the one or more ergonomic values and the at least one notification.

11. The non-transitory processor-readable storage medium of claim 10, wherein determining one or more ergonomic parameter values comprises determining multiple ergonomic parameter values comprising two or more of an ergonomic parameter value pertaining to the individual's distance from at least one device screen, an ergonomic parameter value pertaining to illumination in the work environment, and an ergonomic parameter value pertaining to the individual's posture.

12. The non-transitory processor-readable storage medium of claim 11, wherein determining multiple ergonomic parameter values comprises generating an ergonomic index by aggregating the multiple ergonomic parameter values in conjunction with weights applied to the multiple ergonomic parameter values.

13. The non-transitory processor-readable storage medium of claim 10, wherein performing one or more automated actions comprises generating and outputting, to the individual via one or more automated systems, one or more recommendations for improving at least one of the one or more ergonomic parameter values.

14. The non-transitory processor-readable storage medium of claim 10, wherein generating the at least one notification comprises generating the at least one notification based at least in part on a comparison of the one or more ergonomic parameter values to one or more respective predetermined threshold values.

15. The non-transitory processor-readable storage medium of claim 10, wherein obtaining ergonomic-related data comprises capturing ergonomic-related data pertaining to the individual within the work environment using at least one camera associated with a device of the individual.

16. An apparatus comprising:
at least one processing device comprising a processor coupled to a memory;
the at least one processing device being configured:
to obtain ergonomic-related data pertaining to one or more of an individual within a work environment and the work environment;
to determine one or more ergonomic parameter values by processing at least a portion of the obtained ergonomic-related data using one or more models;
to generate and output, to the individual via one or more automated systems, at least one notification based at least in part on the one or more ergonomic parameter values; and
to perform one or more automated actions based at least in part on one or more of the one or more ergonomic values and the at least one notification.

17. The apparatus of claim 16, wherein determining one or more ergonomic parameter values comprises determining multiple ergonomic parameter values comprising two or more of an ergonomic parameter value pertaining to the individual's distance from at least one device screen, an ergonomic parameter value pertaining to illumination in the work environment, and an ergonomic parameter value pertaining to the individual's posture.

18. The apparatus of claim 17, wherein determining multiple ergonomic parameter values comprises generating an ergonomic index by aggregating the multiple ergonomic parameter values in conjunction with weights applied to the multiple ergonomic parameter values.

19. The apparatus of claim 16, wherein performing one or more automated actions comprises generating and outputting, to the individual via one or more automated systems, one or more recommendations for improving at least one of the one or more ergonomic parameter values.

20. The apparatus of claim 16, wherein generating the at least one notification comprises generating the at least one notification based at least in part on a comparison of the one or more ergonomic parameter values to one or more respective predetermined threshold values.
